(19) United States
(12) Patent Application Publication
(10) Pub. No.: US 2013/0107064 A1
(43) Pub. Date: May 2, 2013

(54) SENSOR AIDED IMAGE STABILIZATION

(71) Applicants: Subramaniam VENKATRAMAN, Fremont, CA (US); Carlos M. Puig, Santa Clara, CA (US)

(72) Inventors: Subramaniam VENKATRAMAN, Fremont, CA (US); Carlos M. Puig, Santa Clara, CA (US)

(73) Assignee: QUALCOMM Incorporated, San Diego, CA (US)

(21) Appl. No.: 13/455,832

(22) Filed: Apr. 25, 2012

Related U.S. Application Data
(60) Provisional application No. 61/552,382, filed on Oct. 27, 2011.

(51) Int. Cl. H04N 5/232

(52) U.S. Cl. CPC H04N 5/23258
USPC 348/208.2

(57) ABSTRACT

Techniques described herein provide a method for improved image and video stabilization using inertial sensors. Gyroscopes, accelerometers and magnetometers are examples of such inertial sensors. The movement of the camera causes shifts in the image captured. Image processing techniques may be used to track the shift in the image on a frame by frame basis. The movement of the camera may be tracked using inertial sensors. By calculating the degree of similarity between the image shift as predicted by image processing techniques with shift of the device estimated using one or more inertial sensor, the device may estimate the portions of the image that are stationary and those that are moving. Stationary portions of the image may be used to transform and align the images. For video stabilization, the realigned images may be combined to generate the video. For image stabilization, the realigned images may be either added or averaged to generate the de-blurred image.

### CROSS-REFERENCES TO RELATED APPLICATIONS

This application claims priority to U.S. Provisional Application No. 61/552,382 entitled “SENSOR AIDED VIDEO AND IMAGE STABILIZATION,” filed Oct. 27, 2011, and is hereby incorporated by reference.

### BACKGROUND OF THE INVENTION

Image stabilization aims to de-blur the image and video stabilization aims to stabilize videos to eliminate unintentional tremor and shake. Both video shake and image blur can result from motion introduced from the camera capturing the image. Shift and blur due to the motion introduced from camera shake can be minimized using known image analysis techniques to minimize offsets between consecutive frames of a video. However, these techniques from the related art suffer from an inherent limitation that they cannot distinguish between camera motion and subject moving in the field of view.

Motion blur due to camera shake is a common problem in photography, especially in conditions involving zoom and low light. Pressing a shutter release button on the camera can itself cause the camera to shake. This problem is especially prevalent in compact digital cameras and cameras on cellular phones, where optical stabilization is not common.

The sensor of a digital camera creates an image by integrating photons over a period of time. If during this time—the exposure time—the image moves, either due to camera or object motion, the resulting image will exhibit motion blur. The problem of motion blur due to camera shake is increased when a long focal length (zoom) is employed, since a small angular change of the camera creates a large displacement of the image. The problem is exacerbated in situations when long exposure is needed, either due to lighting conditions, or due to the use of a small aperture.

One method to minimize blur in images with a long exposure time is to calculate the point spread function of the image. The blurred image can then be de-convolved with the point spread function to generate a de-blurred image. This operation is computationally expensive and difficult to perform on a small mobile device.

Embodiments of the invention address these and other problems.

### SUMMARY

Video stabilization aims to stabilize videos to eliminate unintentional tremor and shake from videos and image stabilization aims to reduce image blur. Both video shake and image blur can result from motion introduced from the camera capturing the image. Shift and blur due to the motion introduced from camera shake can be minimized using known image analysis techniques to minimize offsets between consecutive frames of a video. However, these techniques from the related art suffer from an inherent limitation that they cannot distinguish between camera motion and subject moving in the field of view.

Integrated inertial MEMS sensors have recently made their way onto low-cost consumer cameras and cellular phone cameras and provide an effective way to address this problem. Accordingly, a technique for video and image stabilization provided herein utilizes inertial sensor information for improved stationary object detection. Gyroscopes, accelerometers and magnetometers are examples of such inertial sensors. Inertial sensors provide a good measure for the movement of the camera. This includes movements caused by panning as well as unintentional tremor.

The movement of the camera causes shifts in the image captured. Known image processing techniques may be used to track the shift in the image on a frame-by-frame basis. In embodiments of the invention, the movement of the camera is also tracked using inertial sensors like gyroscopes. The expected image shift due to the camera motion (as measured by the inertial sensors) is calculated by appropriately scaling the calculated angular shift taking into account the camera's focal length, pixel pitch, etc.

By calculating the correlation between the image shift as predicted by known image processing techniques with that estimated using an inertial sensor, the device can estimate the regions of the image that are stationary and those that are moving. Some regions of the image may show strong correlation between the inertial sensor estimated image shift and the image shift calculated by known image processing techniques.

For video stabilization, once a stationary component or object from the image is identified, image rotations, shifts or other transforms for this stationary component can be calculated and applied to the entire image frame. Subject motion which typically causes errors in image processing based video stabilization does not degrade performance of this technique, since the moving regions of the image in the frame are discounted while calculating the shift in the image. These different aligned images can then be combined to form a motion-stabilized video.

For image stabilization, a similar technique can also be used to minimize blur in images due to camera motion. Instead of obtaining one image with a long exposure time, one can obtain multiple consecutive images with short exposure times. These images will typically be underexposed. Simultaneously, the movement of the camera can be captured by logging data from inertial sensors like gyroscopes and accelerometers. In a manner similar to that described above, the multiple images can be aligned by identifying the portions of the image which correspond to stationary objects and calculating the motion of these portions of the image. These aligned images can then be cropped and added, averaged or combined to create a new image which will have significantly reduced blur compared to the original image.

The advantage of this technique as opposed to estimating the transforms between images using image data alone is that it will not be affected by subject motion in the image, since the moving regions of the image are discounted while calculating the shift in the image. The advantage over estimating the transforms between images using inertial sensors alone is that we will get more accurate transforms which are not affected by sensor in-idealities like bias and noise.

An example of a method for outputting a de-blurred image may include obtaining a sequence of images using a camera and transforming at least one image from the sequence of images. In some aspects, a method for transforming at least one image includes identifying multiple portions of the image; detecting a shift associated with each of the multiple portions of the image; detecting a motion using a sensor mechanically coupled to the camera; deriving a projected shift for the image based on the detected motion of the camera using the sensor; comparing the projected shift associated with the motion using the sensor with the shift associated with each portion of the image; identifying a portion of the image with a shift that is most similar to the projected shift associated with the motion detected using the sensor, as a stationary portion of the image; and transforming the image using the shift associated with the stationary portion of the image. The transformed image may be combined with one or more images from the sequence of images to composite a de-blurred image. In one method performing an embodiment of the invention, transforming the image includes spatially aligning the image to other images from the sequence of images.

In one example setting, compositing the de-blurred image may comprise adding a plurality of data points from the plurality of images to composite the de-blurred image. In another example setting, compositing the de-blurred image may comprise averaging a plurality of data points from the plurality of images to composite the de-blurred image. In some implementations, performing the method includes cropping at least one image to include in the compositing process, areas of the at least one image that have overlap with areas of at least another image from the sequence of images. In one instance, the images from the sequence of images are underexposed. In another instance, the images from the sequence of images have normal exposure.

In one implementation of the method, detecting the shift associated with each of the multiple portions of the image may include associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. In another implementation of the method, detecting the shift associated with each of the multiple portions of the image may comprise analyzing a plurality of similarly situated corresponding portions throughout the sequence of images.

Implementations of such a method may also include one or more of the following features. The projected shift from the above described method for the image from the sequence of images may be derived using a scaled value of the motion detected from the sensor. The sensor may be an inertial sensor such as a gyroscope, an accelerometer or a magnetometer. The shift in the image may be from movement of the camera obtaining the image. The shift in the image may also be from movement by an object in a field of view of the camera. The shift from different features in the image may be correlated with the motion detected using the sensor. The camera may be non-stationary causing some of the shift. Also, the similarity in the shift of the stationary portion of the image and the projected shift associated with the motion detected using the sensor may be identified by deriving a correlation between the shift of the multiple portions of the image and the projected shift associated with the motion detected using the sensor. Identifying multiple portions of the image may comprise identifying multiple features from the image.

An exemplary device implementing the method may include a processor, a camera for obtaining images, a sensor for detecting motion associated with the device, and a non-transitory computer-readable storage medium coupled to the processor. The non-transitory computer-readable storage medium may include code executable by the processor for implementing a method comprising obtaining a sequence of images using the camera and transforming at least one image from the sequence of images. Transforming each image may include identifying multiple portions of the image; detecting a shift associated with each of the multiple portions of the image; detecting a motion using the sensor mechanically coupled to the camera; deriving a projected shift for the image based on the detected motion of the camera using the sensor; comparing the projected shift associated with the motion using the sensor with the shift associated with each portion of the image; identifying a portion of the image with a shift that is most similar to the projected shift associated with the motion detected using the sensor, as a stationary portion of the image; and transforming the image using the shift associated with the stationary portion of the image. The transformed image may be combined with other images from the sequence of images to composite a de-blurred image. In one implementation of the device, transforming the image may include spatially aligning the image to other images from the sequence of images.

In one example setting, compositing the de-blurred image using the device may comprise adding a plurality of data points from the plurality of images to composite the de-blurred image. In another example setting, compositing the de-blurred image using the device may comprise averaging a plurality of data points from the plurality of images to composite the de-blurred image. In some implementations, performing the method by the device includes cropping at least one image to include in the compositing process, areas of the at least one image that have overlap with areas of at least another image from the sequence of images. In one instance, the images from the sequence of images are underexposed. In another instance, the images from the sequence of images have normal exposure.

In one implementation of the device, detecting the shift associated with each of the multiple portions of the image may include associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. In another implementation of the device, detecting the shift associated with each of the multiple portions of the image may comprise analyzing a plurality of similarly situated corresponding portions throughout the sequence of images.

Implementations of such a device may also include one or more of the following features. The projected shift from the above described device for the image from the sequence of images may be derived using a scaled value of the motion detected from the sensor. The sensor may be an inertial sensor such as a gyroscope, an accelerometer or a magnetometer. The shift in the image may be from movement of the camera obtaining the image. The shift in the image may also be from movement by an object in a field of view of the camera. The shift from different features in the image may be correlated with the motion detected using the sensor. The camera may be non-stationary causing some of the shift. Also, the similarity in the shift of the stationary portion of the image and the projected shift associated with the motion detected using the sensor may be identified by deriving a correlation between the shift of the multiple portions of the image and the projected shift associated with the motion detected using the sensor. Identifying multiple portions of the image may comprise identifying multiple features from the image.

An example of a non-transitory computer-readable storage medium coupled to a processor is discussed, wherein the non-transitory computer-readable storage medium comprises a computer program executable by the processor for implementing a method comprising obtaining a sequence of images using a camera and transforming at least one image from the sequence of images. Transforming each image may include identifying multiple portions of the image; detecting a shift associated with each of the multiple portions of the image; detecting a motion using the sensor mechanically coupled to the camera; deriving a projected shift for the image based on the detected motion of the camera using the sensor; comparing the projected shift associated with the motion using the sensor with the shift associated with each portion of the image; identifying a portion of the image with a shift that is most similar to the projected shift associated with the motion detected using the sensor, as a stationary portion of the image; and transforming the image using the shift associated with the stationary portion of the image. The transformed image may be combined with other images from the sequence of images to composite a de-blurred image. In one implementation of the non-transitory computer-readable storage medium, transforming the image may include spatially aligning the image to other images from the sequence of images.

In one example setting for the non-transitory computer-readable storage medium, compositing the de-blurred image may comprise adding a plurality of data points from the plurality of images to composite the de-blurred image. In another example setting for the non-transitory computer-readable storage medium, compositing the de-blurred image may comprise averaging a plurality of data points from the plurality of images to composite the de-blurred image. In some implementations, performing the method by the computer program on the non-transitory computer-readable storage medium includes cropping at least one image to include in the compositing process, areas of the at least one image that have overlap with areas of at least another image from the sequence of images. In one instance, the images from the sequence of images are underexposed. In another instance, the images from the sequence of images have normal exposure.

In one implementation of the computer program on the non-transitory computer-readable storage medium, detecting the shift associated with each of the multiple portions of the image may include associating, from the image, one or more portions of the image with a same relative location in the one or more other images from the sequence of images to generate a sequence of portions from the images, and determining the shift associated with the one or more portions of the image using deviations in a plurality of pixels in the sequence of portions from the images. In another implementation of the computer program for non-transitory computer-readable storage medium, detecting the shift associated with each of the multiple portions of the image may comprise analyzing a plurality of similarly situated corresponding portions throughout the sequence of images.

Implementations of such a non-transitory computer-readable storage medium may also include one or more of the following features. The projected shift from the above described non-transitory computer-readable storage medium for the image from the sequence of images may be derived using a scaled value of the motion detected from the sensor. The sensor may be an inertial sensor such as a gyroscope, an accelerometer or a magnetometer. The shift in the image may be from movement of the camera obtaining the image. The shift in the image may also be from movement by an object in a field of view of the camera. The shift from different features in the image may be correlated with the motion detected using the sensor. The camera may be non-stationary causing some of the shift. Also, the similarity in the shift of the stationary portion of the image and the projected shift associated with the motion detected using the sensor may be identified by deriving a correlation between the shift of the multiple portions of the image and the projected shift associated with the motion detected using the sensor. Identifying multiple portions of the image may comprise identifying multiple features from the image.

An example apparatus performing a method for de-blurring an image may include means for obtaining a sequence of images using a camera and means for transforming at least one image from the sequence of images. Transforming each image may include means for identifying multiple portions of the image; means for detecting a shift associated with each of the multiple portions of the image; means for detecting a motion using the sensor mechanically coupled to the camera; means for deriving a projected shift for the image based on the detected motion of the camera using the sensor; means for comparing the projected shift associated with the motion using the sensor with the shift associated with each portion of the image; means for identifying a portion of the image with a shift that is most similar to the projected shift associated with the motion detected using the sensor, as a stationary portion of the image; and means for transforming the image using the shift associated with the stationary portion of the image. The transformed image may be combined with other images from the sequence of images to composite a de-blurred image. In one implementation of the apparatus, means for transforming the image may include spatially aligning the image to other images from the sequence of images.

In one example setting for the apparatus, compositing the de-blurred image may comprise means for adding a plurality of data points from the plurality of images to composite the de-blurred image. In another example setting for the apparatus, compositing the de-blurred image may comprise means for averaging a plurality of data points from the plurality of images to composite the de-blurred image. In some implementations, performing the method by the computer program on the apparatus includes means for cropping at least one image to include in the compositing process, areas of the at least one image that have overlap with areas of at least another image from the sequence of images. In one instance, the images from the sequence of images are underexposed. In another instance, the images from the sequence of images have normal exposure.

In one implementation of the apparatus, detecting the shift associated with each of the multiple portions of the image may include means for associating, from the image, one or more portions of the image with a same relative location in the one or more other images from the sequence of images to generate a sequence of portions from the images, and means for determining the shift associated with the one or more portions of the image using deviations in a plurality of pixels in the sequence of portions from the images. In another implementation of the computer program for apparatus, detecting the shift associated with each of the multiple portions of the image may comprise means for analyzing a plurality of similarly situated corresponding portions throughout the sequence of images.

Implementations of such an apparatus may also include one or more of the following features. The projected shift from the above described apparatus for the image from the sequence of images may be derived using a scaled value of the motion detected from the sensor. The sensor may be an inertial sensor such as a gyroscope, an accelerometer or a magnetometer. The shift in the image may be from movement of the camera obtaining the image. The shift in the image may also be from movement by an object in a field of view of the camera. The shift from different features in the image may be correlated with the motion detected using the sensor. The camera may be non-stationary causing some of the shift. Also, the similarity in the shift of the stationary portion of the image and the projected shift associated with the motion detected using the sensor may be identified by deriving a correlation between the shift of the multiple portions of the image and the projected shift associated with the motion detected using the sensor. Identifying multiple portions of the image may comprise a means for identifying multiple features from the image.

The foregoing has outlined rather broadly the features and technical advantages of examples according to disclosure in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 is an exemplary figure illustrating a setting that would benefit from embodiments of the currently described invention.

FIG. 2 is an exemplary mobile device equipped with inertial sensors.

FIG. 3 is a graph comparing the image shift as calculated using a gyroscope output and image processing techniques.

FIG. 4 is a non-limiting exemplary graphical representation of the motion associated with the device and the motion detected from the different portions of the image, respectively.

FIG. 5 is a logical block diagram illustrating a non-limiting embodiment for stabilizing a video.

FIG. 6 is a flow diagram, illustrating an embodiment of the invention for stabilizing a video.

FIG. 7 is a flow diagram, illustrating an embodiment of the invention for stabilizing a video.

FIG. 8 is a logical block diagram illustrating a non-limiting embodiment of reducing blur in an image.

FIG. 9 is a flow diagram, illustrating an embodiment of the invention for de-blurring an image.

FIG. 10 is an illustration of an embodiment of the invention for de-blurring an image.

FIG. 11 is flow diagram, illustrating an embodiment of the invention for de-blurring an image.

FIG. 12 illustrates an exemplary computer system incorporating parts of the device employed in practicing embodiments of the invention.

### DETAILED DESCRIPTION

Techniques for video and image stabilization are provided. Video stabilization aims to stabilize hand-held videos to eliminate hand tremor and shake. Camera shake can be minimized using known image analysis techniques to minimize offsets between consecutive frames of a video. However, all these techniques suffer from an inherent limitation that they cannot distinguish between camera motion and subject motion. Furthermore, these techniques are affected by motion blur, changes in lighting conditions, etc.

Integrated inertial MEMS sensors have recently made their way onto low-cost mobile devices such as consumer cameras and smart phones with camera capability and provide an effective way to address image distortion in videos and pictures. Accordingly, techniques for video and image stabilization provided herein utilize sensor information for improved stationary object detection. Gyroscopes, accelerometers and magnetometers are all examples of such sensors. Especially, inertial sensors provide a good measure for the movement of the camera. This includes movements caused by panning as well as unintentional tremor.

The movement of the camera causes shifts in the image captured. Known image processing techniques may be used to track the shift in the image on a frame-by-frame basis. In embodiments of the invention, the movement of the camera is tracked using inertial sensors like gyroscopes. The expected image shift due to the camera motion (as measured by the inertial sensors) is calculated by appropriately scaling the calculated angular shift taking into account the cameras focal length, pixel pitch, etc.

By comparing the similarity between the image shift as predicted by known image processing techniques with that estimated using an inertial sensor, the device can estimate the regions of the image that are stationary and those that are moving. Some regions of the image may show close similarity between the inertial sensor estimated image shift and the image shift calculated by known image processing techniques. The regions of the image may be defined as components or portions of the image or individual fine grained features identified by using known techniques such as scale invariant feature transform (SIFT). SIFT is an algorithm in computer vision to detect and describe local features in images. For any object in an image, interesting points on the object can be extracted to provide a “feature description” of the object. This description, extracted from a training image, can then be used to identify the object when attempting to locate the object in an image containing many other objects.

For video stabilization, once a stationary portion from the image is identified, image rotations, shifts or other transforms for this stationary portion can be calculated and applied to the entire image frame. Moving objects from the field of view that typically cause errors in image processing based video stabilization do not degrade performance for this technique, since the moving regions of the image are discounted while calculating the shift in the image. These different aligned images can then be combined to form a motion-stabilized video.

For image stabilization, a similar technique can also be used to minimize blur in images due to camera motion. Instead of obtaining one image with a long exposure time, the device can obtain multiple consecutive images with short exposure times. These images will typically be underexposed. This may be compensated by appropriately scaling the gain on the image sensor. Simultaneously, the movement of the camera can be captured by logging data points from inertial sensors like gyroscopes and accelerometers. The multiple images can be aligned by identifying portions of the image which correspond to stationary objects and calculating the motion of these portions of the image. These aligned images can then be cropped and added or averaged to create a new image which will have significantly reduced blur compared to the resultant image without using these de-blurring techniques.

It is advantageous to use inertial sensors coupled to the camera in detecting the stationary portions of the image since the inertial sensors enable distinguishing between the shift from the unintentional tremor of the camera versus the shift from the moving objects in the field of view. However, the shift derived using the sensor input may be used mostly to identify the stationary portion and not to transform/align the image itself. Once the stationary portion is identified, the shift for the stationary portion that is derived using image processing techniques is used to transform/align the entire image. This is advantageous because the projected shift using the sensors may have greater error due to calibration errors and environmental noise than the shift derived using image processing techniques.

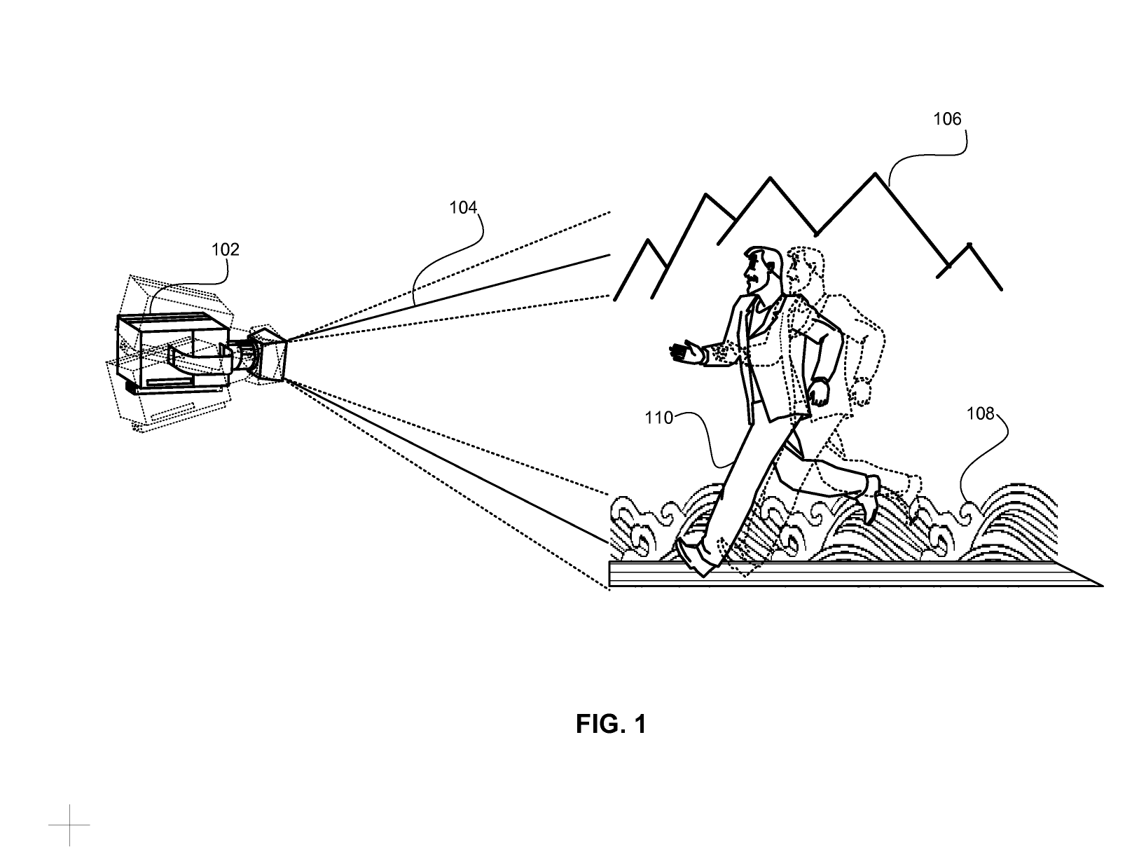

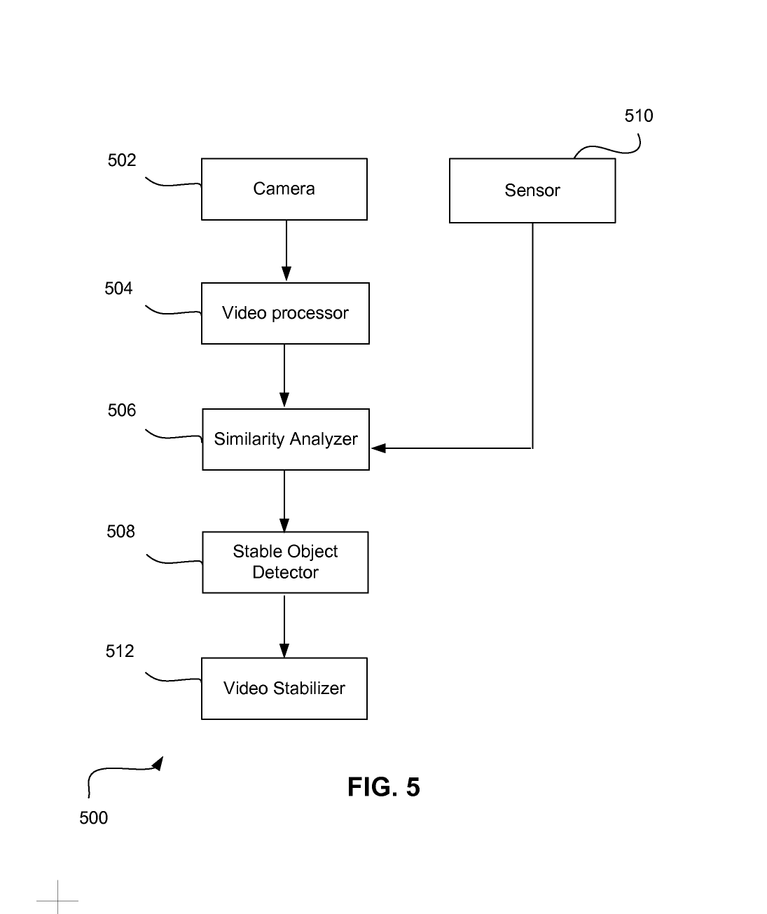

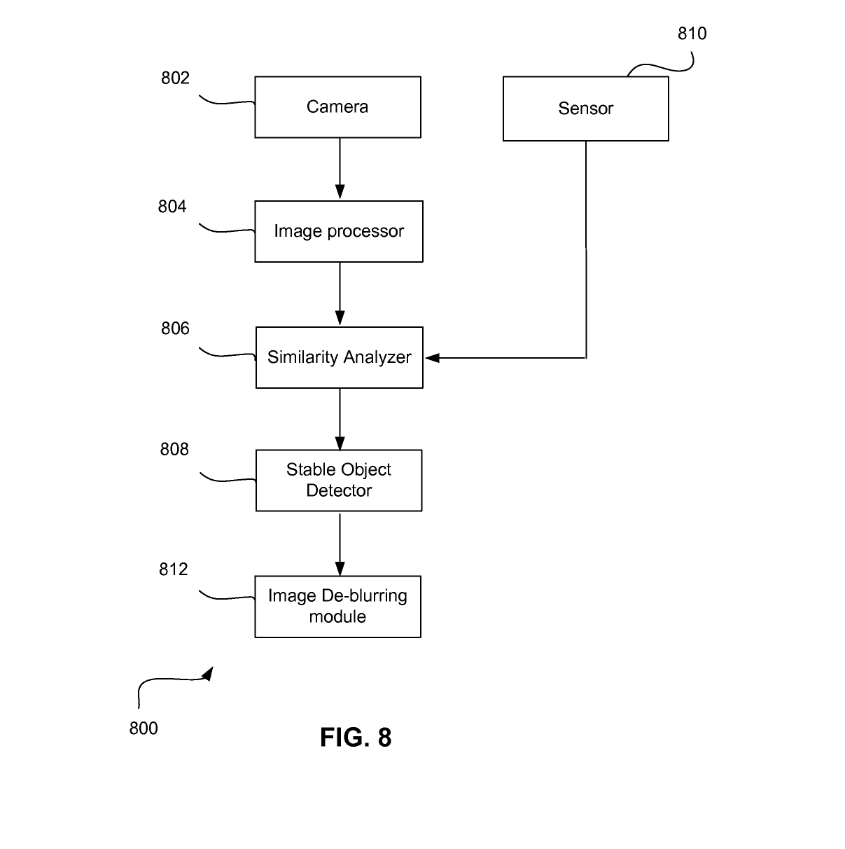

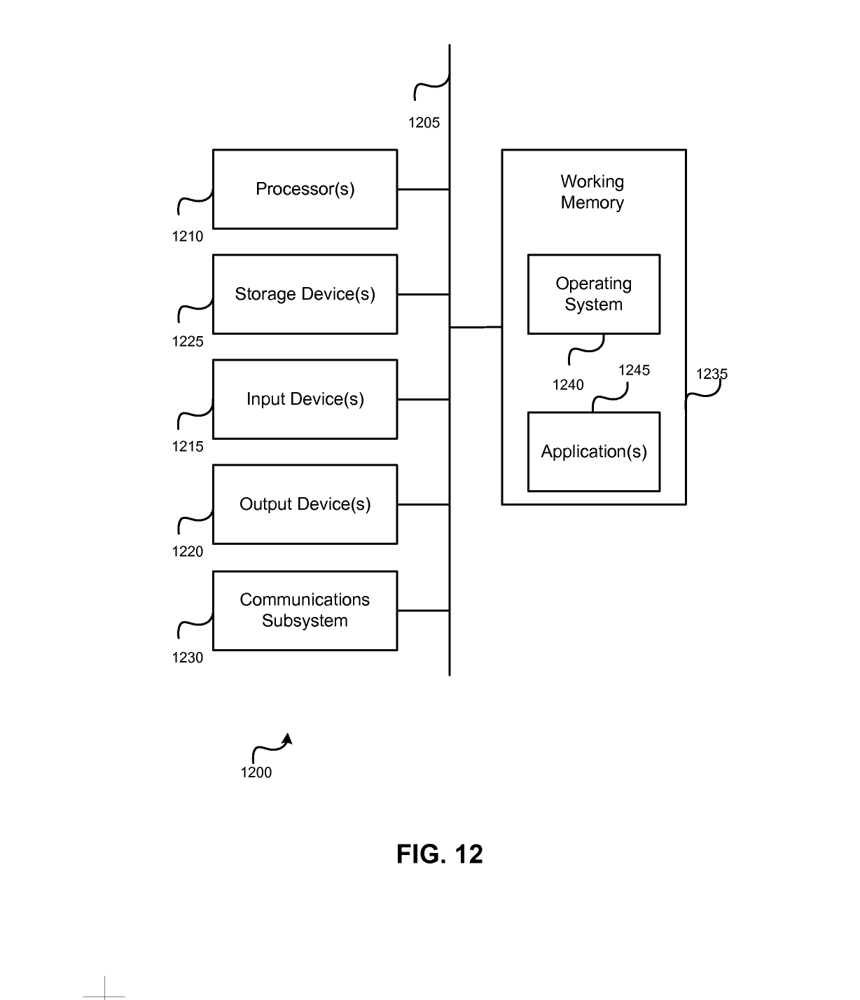

FIG. 1 is an exemplary setting illustrating the inadequacy of traditional techniques for detecting a stationary object in an image or video in situations where the capturing device is unstable and contributes to an image shift. Referring to FIG. 1, a non-stationary device 102 comprising a camera in its field of view has a person walking down the sidewalk 110 and scenery including mountains 106 and ocean (with waves) 108. As described in more detail in FIG. 5, FIG. 8 and FIG. 12, the non-stationary device may have a camera and other sensors mechanically coupled to the device. In one aspect, the non-stationary device 102 may be a mobile device. In another aspect, the device 102 is non-stationary because it is mechanically coupled to another moving object. For example, the device 102 may be coupled to a moving vehicle, person, or robot. Computer system 1200, further discussed in reference to FIG. 12 below, can represent some of the components of the device 102.

Referring again to FIG. 1, the waves in the ocean 108 may constitute a large portion of the image in the field of view 104 of the camera coupled to the non-stationary device 102. Also, the person 110 may be moving as well. In addition to the moving waves 108 in the background and the moving person 110 in the foreground, the device 102 may be non-stationary. In a common scenario, the hand tremor from a person handling the device contributes to the motion of the device 102 and consequently the camera. Therefore, the obtained images or video have motion from the moving waves 108, the moving person 110 and the hand tremor. Although the mountain ranges 106 are stationary, the device may not recognize the mountain ranges 106 as stationary due to the motion contributed to the image from the hand tremor. This inability to distinguish between hand tremor and motion by the objects in the image results in difficulty differentiating between a moving object and a stationary object. Also, algorithms in related art that associate larger objects as stationary objects may not appropriately find stationary objects in the scene described in FIG. 1, since the waves in the ocean 108 are continuously moving and the mountains 106 have continuous shift due to the constant movement of the device 102. It is difficult to accurately calculate the shake of the camera without finding stationary objects and the associated shift with the stationary object and stabilize the video or de-blur the image.

For video stabilization, embodiments of the current invention assist in removing some of the choppiness and tremor associated with the shake of the camera. In a typical scenario, the user handling the video camera introduces a shift in the sequence of images in the video stream due to unintentional hand-tremor. The resultant video is unpleasing to the eye due to the constant shift in the video frames due to the shake of the camera.

For image stabilization, embodiments of the current invention facilitate in at least partially resolving image blur caused by tremor and shake of the camera. Referring to FIG. 1, for image stabilization, the camera 102 coupled to the device is taking a digital image instead of a video image of the scenery. The shake from the hand of the person handling the camera can cause the image to blur. The resultant picture has blur when there is continuous motion from hand tremor or movement in the field of view during the exposure window. In low light conditions, the blur is significantly pronounced since the time period for the exposure window is increased to capture more light and any movement is captured creating the unwanted blur in the image.

Related video and image processing techniques are valuable in detecting motion associated with an image or portions of the image. However, these traditional techniques have difficulty in isolating a stationary object from a scene with a number of moving components, where the device obtaining the image contributes to the motion. In one aspect, inertial sensors coupled to the device may be used in detecting the motion associated with the device obtaining the image. Aspects of such a technique are described herein.

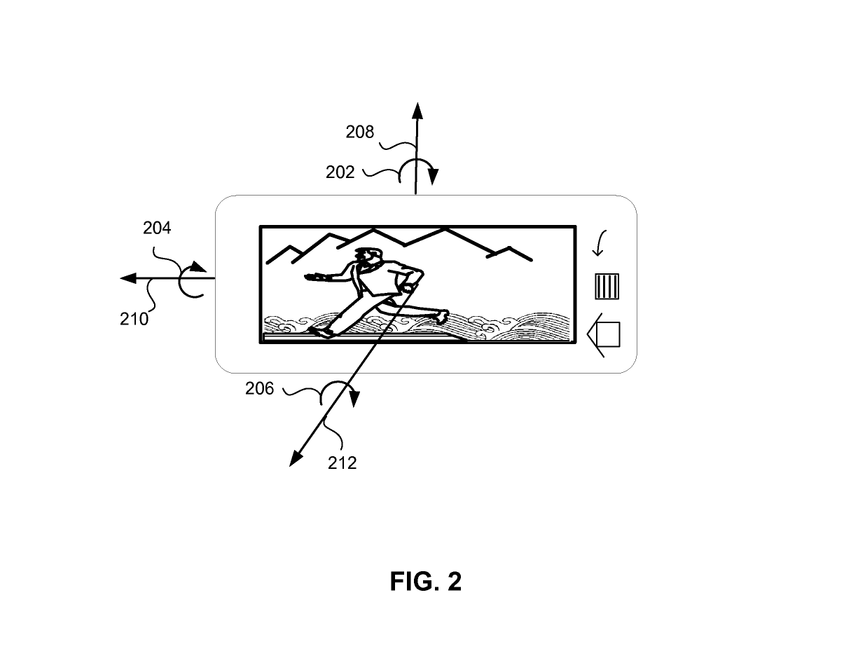

FIG. 2 is an exemplary mobile device equipped with inertial sensors. The device represented in FIG. 2 may comprise components of a computer system referenced in FIG. 12 and embodiments of the invention as referenced in FIG. 8 and FIG. 12. The system may also be equipped with inertial sensors. Most modern day mobile devices such as cell phones and smart phones are equipped with inertial sensors. Examples of inertial sensors include gyroscopes and accelerometers. Gyroscopes measure the angular velocity of the camera along three axes and accelerometers measure both the acceleration due to gravity and the dynamic acceleration of the camera along three axes. These sensors provide a good measure of the movement of the camera. The movements include movements caused by panning as well as unintentional tremor. Referring to FIG. 2, the angular movement of the mobile device around the X, Y, and Z axes is represented by the arcs 202, 204 and 206 and may be measured by the gyroscope. The movement along the X, Y and Z axes is represented by the straight lines 208, 210 and 212 and may be measured using an accelerometer.

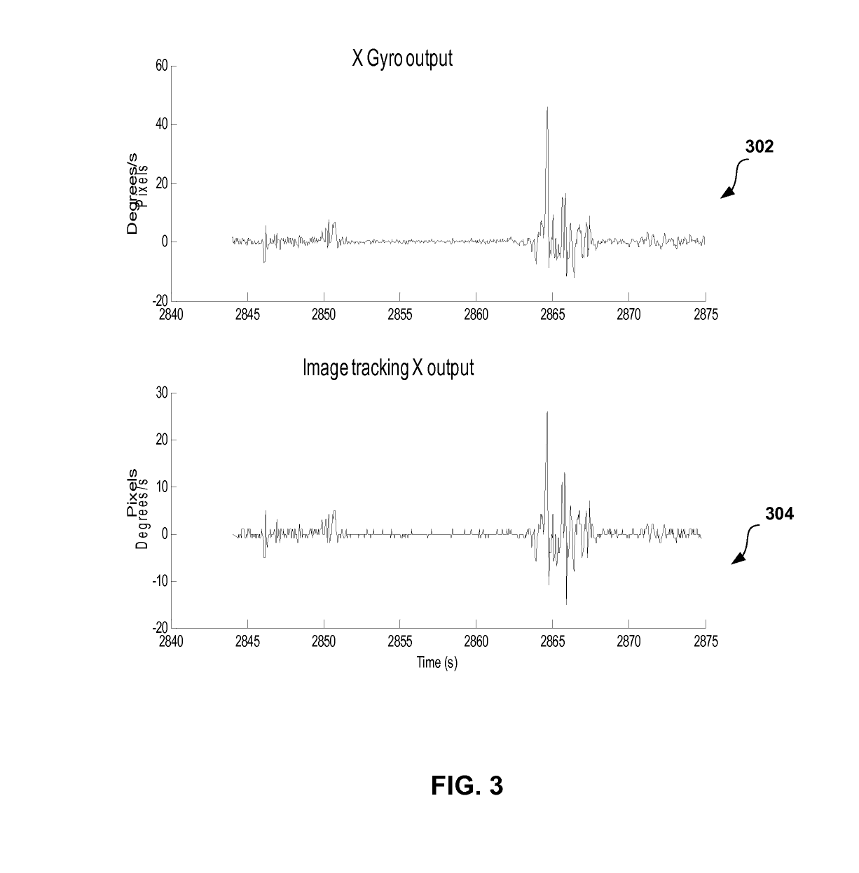

FIG. 3 is a graph comparing the image shift as calculated using gyroscope output and image processing techniques. The image processing is performed on a sequence of images to determine the image shift associated with a unitary frame or image. The objects in the field of view of the device capturing the video for analysis are stationary. The only shift in the video is due to the motion associated with the device capturing the video. For instance, the motion could result from hand tremor of the person handling the device capturing the video. The upper graph in FIG. 3 (302) is a graph of the angular movement of the device around the X-axis as calculated using the gyroscope output from the gyroscope coupled to the device. The lower graph in FIG. 3 (304) is a graph of the angular movement of the device around the X-axis as calculated using image processing techniques on the sequence of images belonging to the video directly. As seen in FIG. 3, the graphs for the image shift as calculated using the gyroscope output (302) and the image processing techniques (304) are almost identical when all objects in the video are stationary. Therefore, the shift in the image as calculated using the gyroscope is almost identical to the shift in the image as calculated using image processing techniques when the objects in the field of view of the capturing device are all stationary. Different portions or identified objects may be isolated, analyzed for shift and compared separately to the shift contributed by gyroscope to discount the shift from the motion of the moving objects and identify the stationary objects in the video. The same principle can be used for videos that include moving objects to identify stationary objects. However, even though the projected shift from the hand tremor using the gyroscope is similar to the shift derived by analyzing the sequence of images using image processing techniques, the shifts are not identical. Therefore, it is beneficial to first exploit the projected shift using the gyroscope to identify the stationary object and then employ the shift for the stationary portion derived using image processing techniques to the entire image.

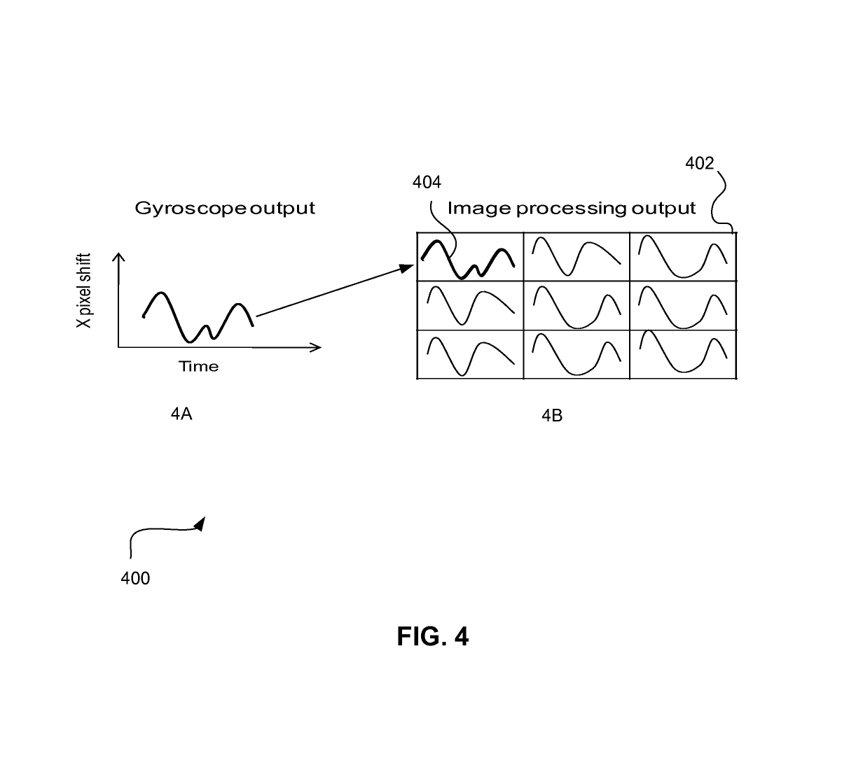

FIG. 4 is a non-limiting exemplary graphical representation of the motion associated with the device capturing the image/video and the motion detected from the different portions of the image, respectively. FIG. 4A represents the motion associated with the device and detected using a gyroscope. A gyroscope is used as an exemplary inertial sensor; however, one or more sensors may be used alone or in combination to detect the motion associated with the device. The projected image shift due to camera motion can also be calculated by integrating the gyroscope output and appropriately scaling the integrated output taking into account camera focal length, pixel pitch, etc.

FIG. 4B represents the shift associated with each of the multiple portions of the image (block 402). The shift detected in the image using image processing techniques is a combination of the shift from the device and the shift due to motion of the objects in the field of view of the camera. In one aspect, the motion associated with each of the multiple portions of the image is detected by analyzing a sequence of images. For example, from each image from a sequence of images, a portion from the image with the same relative location in the image is associated to form a sequence of portions from the images. Deviations in the sequence of portions from the images may be analyzed to determine the shift associated with that particular portion of the image.

As described herein, a sequence of images is a set of images obtained one after the other, in that order, but is not limited to obtaining or utilizing every consecutive image in a sequence of images. For example, in detecting the motion associated with a sequence of images, from a consecutive set of images containing the set of images 1, 2, 3, 4, 5, 6, 7, 8, and 9, the image processing technique may only obtain or utilize the sequential images 2, 6 and 9 in determining the motion associated with different portions of the image.

In one aspect, a portion of the image may be sub-frames, wherein the sub-frames are groupings of pixels that are related by their proximity to each other, as depicted in FIG. 4B. In other aspects, portions of the image analyzed using image processing for detecting motion can be features. Examples of features may include corners or edges in an image. Techniques such as scale invariant features transform (SIFT) can be used to identify such features as portions of the images. Alternately, optical flow or other suitable image statistics can be measured in different parts of the image and tracked across frames.

Shift calculated by using motion from the sensor and shift detected using image processing techniques for each portion of the image are compared to find a portion from the image which is most similar with the shift detected using the sensor. The portion of the image with the most similarity to the shift detected using the sensor is identified as the stationary portion from the image. One or more portions may be identified as stationary portions in the image (such as portion 404). The comparison for similarity between the shift (using motion) from the sensor and the shift from the portions of the image may be a correlation, sum of squares or any other suitable means.

Referring back to FIG. 1, in the scene, the mountain range 106 is stationary. Traditional techniques may not identify the mountain range 106 as a stationary object in the sequence of images or the video stream due to the motion contributed by the capturing device. However, even though the image obtained would have motion associated with the mountain ranges 106, the above described technique would identify the mountain ranges as stationary objects.

### Stabilizing the Video:

FIG. 5 is a logical block diagram illustrating a non-limiting embodiment of the invention. The logical block diagram represents components of an aspect of the invention encapsulated by the device described in FIG. 12. Referring to FIG. 5, the camera 502 obtains the video image. In one aspect, the video image may be characterized as a continuous stream or sequence of digital images. The camera may have an image sensor, lens, storage memory and various other components for obtaining an image. The video processor 504 may detect motion associated with the different portions of the image using image processing techniques in the related art.

One or more sensors 510 are used to detect motion associated of the camera coupled to the device. The one or more sensors 510 are also coupled to the device reflecting similar motion experienced by the camera. In one aspect, the sensors are inertial sensors that include accelerometers and gyroscopes. Current inertial sensor technologies are focused on MEMS technology. MEMS technology enables quartz and silicon sensors to be mass produced at low cost using etching techniques with several sensors on a single silicon wafer. MEMS sensors are small, light and exhibit much greater shock tolerance than conventional mechanical designs. However, other technologies are also being researched for more sophisticated inertial sensors, such as Micro-Optical-Electro-Mechanical-Systems (MOEMS), that remedy some of the deficiencies related to capacitive pick-up in the MEMS devices. In addition to inertial sensors, other sensors that detect motion related to acceleration, or angular rate of a body with respect to features in the environment may also be used in quantifying the motion associated with the camera.

At logical block 506, the device performs a similarity analysis between the shift associated with the device using sensors 510 coupled to the device and the shift associated with the different portions of the image detected from the video processing 504 of the sequence of images. At logical block 508, one or more stable objects in the image are detected by comparing the shift for portions of the image derived using video processing techniques and the shift for the image derived using detected sensor output. The portion of the image with a similar shift to the shift derived using the detected sensor output is identified as the stationary object.

At logical block 512, for video stabilization, once a stationary component or object from the image is identified, image rotations, shifts or other transforms for this stationary component can be calculated and applied to the entire video frame. Moving objects that typically cause errors in image processing based video stabilization do not degrade performance of this technique, since the moving portions of the image are discounted while calculating the shift in the image. These distinctly aligned images can then be combined to form a motion-stabilized video.

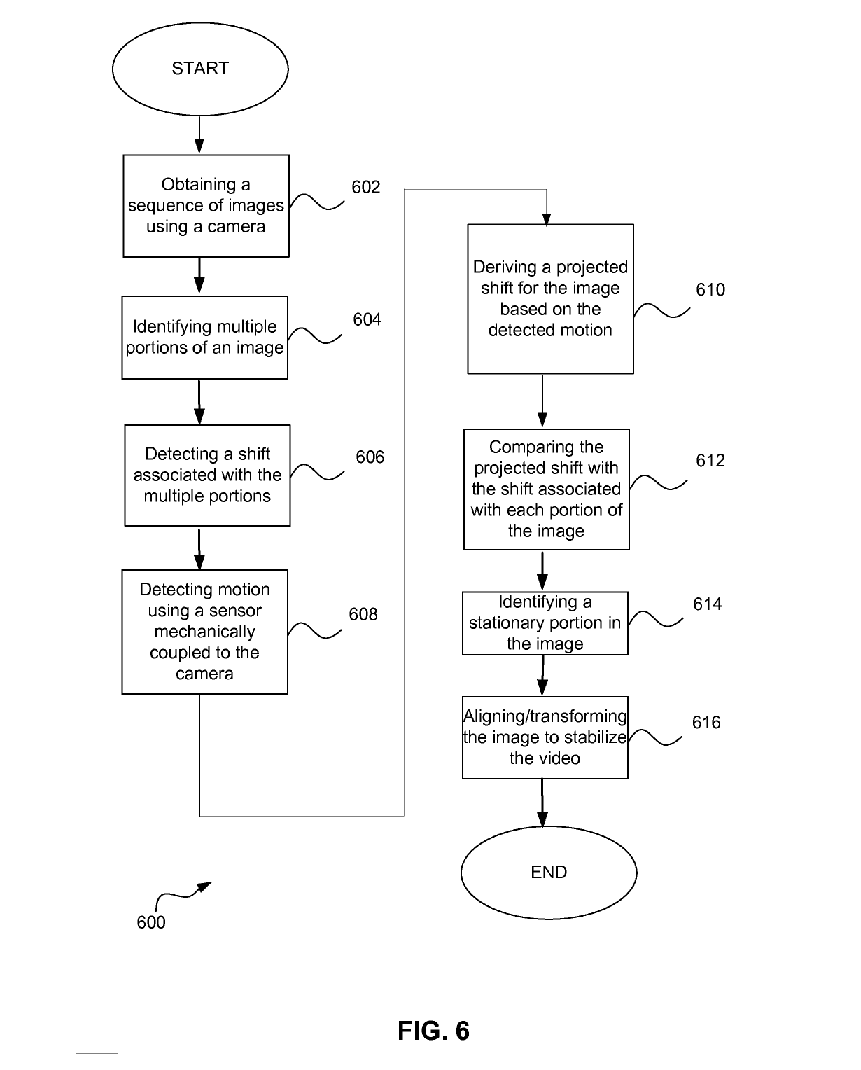

FIG. 6 is a flow diagram, illustrating an embodiment of the invention for stabilizing a video. The method 600 is performed by processing logic that comprises hardware (circuitry, dedicated logic, etc.), software (such as is run on a general purpose computing system or a dedicated machine), firmware (embedded software), or any combination thereof. In one embodiment, the method 600 is performed by device 1200 of FIG. 12.

Referring to FIG. 6, at block 602, the camera mechanically coupled to the device obtains a sequence of images for a video. In one aspect, the video image may be characterized as a continuous stream of digital images. The camera may have an image sensor, lens, storage memory and various other components for obtaining an image.

At block 604, the device identifies multiple portions from an image from the sequence of images. Multiple portions from an image may be identified using a number of suitable methods. In one aspect, the image is obtained in a number of portions. In another aspect, the image is obtained and then separate portions of the image are identified. A portion of the image could be a sub-frame, wherein the sub-frames are groupings of pixels that are related by their proximity to each other, as depicted in FIG. 5(B). In other aspects, portions of the image analyzed using image processing for detecting motion can be features such as corners and edges. Techniques such as scale invariant features transform (SIFT) can be used to identify such features as portions of the images. Alternately, optical flow or other suitable image statistics can be measured in different parts of the image and tracked across frames.

At block 606, the device detects a shift associated with each of the multiple portions of the image. The shift detected in the image using image processing techniques is a combination of the shift due to the motion from the device capturing the video and the motion of the objects in the field of view of the camera. In one aspect, the shift associated with each of the multiple portions of the image is detected by analyzing a sequence of images. For example, from each image from the sequence of images, a portion from the image with the same relative location in the image is associated to form a sequence of portions from the images. Deviations in the sequence of portions from the images may be analyzed to determine the motion associated with that particular portion of the image. As described herein, a sequence of images is a set of images obtained one after the other by the camera coupled to the device, in that order, but the camera is not limited to obtaining or utilizing every consecutive image in a sequence of images.

At block 608, the device detects motion using one or more sensors mechanically coupled to the camera. In one aspect, the sensors are inertial sensors that comprise accelerometers and gyroscopes. Current inertial sensor technologies are focused on MEMS technology. However, other technologies are also being researched for more sophisticated inertial sensors, such as Micro-Optical-Electro-Mechanical-Systems (MOEMS), that remedy some of the deficiencies related to capacitive pick-up in the MEMS devices. In addition to inertial sensors, other sensors that detect motion related to acceleration, or angular rate of a body with respect to features in the environment may also be used in quantifying the motion associated with the camera.

At block 610, the device derives a projected shift for the image based on the detected motion of the camera using the sensor. The projected image shift due to the camera motion (as measured by the inertial sensors) is calculated by appropriately scaling the camera movement, taking into account the camera's focal length, pixel pitch, etc.

At block 612, the device compares the projected shift detected using the sensor with the shift associated with each portion of the image. Shift detected using the sensor and shift detected using image processing techniques for each portion of the image are compared to find a shift associated with a portion from the image which is most similar with the shift detected using the sensor. At block 614, the device identifies a portion from the image which is most similar with the motion detected using the sensor, as a stationary portion of the image. One or more portions may be identified as stationary portions in the image. The comparison between the shift due to the motion from the sensor and the shift calculated from the portions of the image for similarity may be a correlation, sum of squares or any other suitable means.

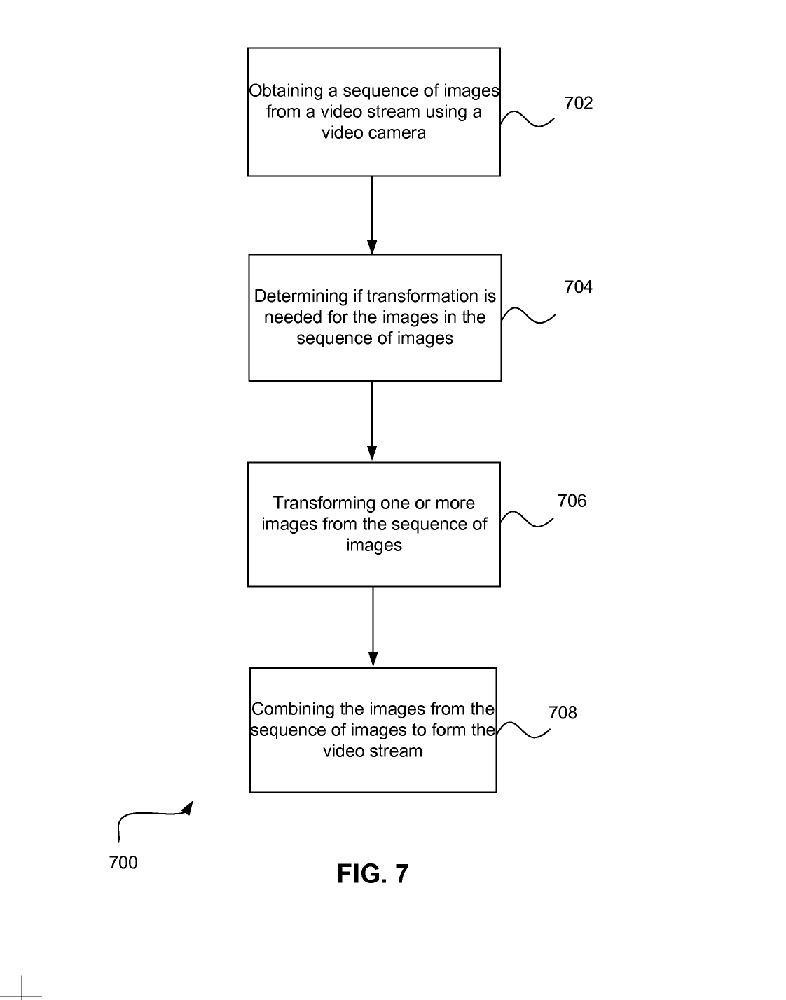

At block 614, for video stabilization, once a stationary component or object from the image is identified, the entire image is transformed (block 616). In one aspect, the image is transformed by aligning the image. The image may be aligned using image rotations, shifts or other transforms calculated from the stationary component and applied to the entire video frame or image. Moving objects which typically cause errors in image processing based video stabilization do not degrade performance of this technique, since the moving regions of the image are discounted while calculating the shift in the image. The images may also need cropping to disregard extraneous borders that do not have overlapping portions in the sequence of images. These different transformed or aligned images can then be combined to form a shift-stabilized video stream as further described in reference to FIG. 7.

In one embodiment, the image or video frame may be directly transformed using the projected shift calculated using the motion detected by the sensors. However, it may be advantageous to use the actual shifts in the portions of the image that are derived using image processing techniques for the stationary portions to adjust the entire image than directly using the projected shift for the transformation. For instance, even though the projected shift and the shift calculated for the stationary portions are similar, the projected shift may have inaccuracies introduced due to the calibration errors from the sensors or noise in the environment of the sensors. Furthermore, the projected shift of the image may be a scaled estimation based on the focal length and may have inaccuracies for that reason as well. Therefore, it may be advantageous to 1) identify the stationary portion (using the projected shift that is derived from the motion detected from the sensors) and 2) use the calculated shift (derived by using image processing techniques) for the stationary portion of the image to transform or adjust the entire image.

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 600.

FIG. 7 is a flow diagram, illustrating an embodiment of the invention for stabilizing a video. The method 700 is performed by processing logic that comprise hardware (circuitry, dedicated logic, etc.), software (such as is run on a general purpose computing system or a dedicated machine), firmware (embedded software), or any combination thereof. In one embodiment, the method 700 is performed by device 1200 of FIG. 12.

Referring to FIG. 7, at block 702, the video camera obtains a sequence of images from a video stream. In one aspect, the video stream may be characterized as a sequence of images over a period of time. As described herein, a sequence of images is a set of images obtained one after the other, in that order, but is not limited to obtaining or utilizing every consecutive image in a sequence of images. For example, in detecting the motion associated with a sequence of images, from a consecutive set of images containing the set of images 1, 2, 3, 4, 5, 6, 7, 8, and 9, the image processing technique may only obtain or utilize the sequential images 2, 6 and 9 in determining the motion associated with different portions of the image.

At block 704, a plurality of images from the sequence of images are analyzed. For each image that is analyzed, the device may determine if the image is affected by a shift in the image in relation to the other images in the sequence of images for the video frame. The device may make this determination by discovering the stationary object in the image and analyzing the shift for that stationary object. For instance, if the device detects a significant shift associated with the stationary portion of image, the device may determine that a transformation of the image is needed. In another aspect, the device may perform image processing techniques on the image to determine that a transformation of the image would be advantageous.

At block 706, the one or more images from the sequence of images that are selected for transformation at block 704 are transformed according to embodiments of invention as described in reference to FIG. 5 and FIG. 6. At block 708, the images from the sequence of images are combined to form the video stream. In one embodiment, only transformed images are combined to form the resultant video stream. However, in another embodiment, the transformed images may be combined with images that were not transformed (because there was low or no shift associated with these non-transformed images).

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 700.

### De-Blurring an Image:

For image stabilization, techniques described herein may be used for de-blurring an image. Image blur can result from motion introduced from the camera capturing the image. Motion blur due to camera shake is a common problem in photography, especially in conditions involving zoom and low light. Pressing a shutter release button on the camera can itself cause the camera to shake. This problem is especially prevalent in compact digital cameras and cameras on cellular phones, where optical stabilization is not common.

The sensor of a digital camera creates an image by integrating photons over a period of time. If during this time—the exposure time—the image moves, either due to camera or object motion, the resulting image will exhibit motion blur. The problem of motion blur due to camera shake is increased when a long focal length (zoom) is employed, since even a small angular change of the camera creates a large displacement of the image. The problem is exacerbated in situations when long exposure is needed, either due to lighting conditions, or due to the use of a small aperture.

Techniques described herein minimize the blur in the resultant image, effectively outputting a de-blurred image. Instead of obtaining one image with a long exposure time, the device can obtain multiple consecutive images with short exposure times. The multiple images can be aligned by identifying portions of the image which correspond to stationary objects and calculating the motion of these portions of the image. These aligned images can then be cropped and added, averaged or combined to create a new image which will have significantly reduced blur compared to the resultant image without using these de-blurring techniques.

FIG. 8 is a logical block diagram illustrating a non-limiting embodiment of the invention. The logical block diagram represents components of an aspect of the invention encapsulated by the device described in FIG. 12. Referring to FIG. 8, the camera 802 obtains a sequence of images. The camera may have an image sensor, lens, storage memory and various other components for obtaining an image. The image processor 804 may detect motion associated with the different portions of the image using image processing techniques in the related art.

One or more sensors 810 are used to detect motion associated with the camera coupled to the device. The sensors used may be similar to those used while discussing 510 for FIG. 5. At logical block 806, the device performs a similarity analysis between the shift associated with the device using sensors 810 coupled to the device and the motion associated with the different portions of the image detected from the image processing 804 of the sequence of images. At logical block 808, one or more stationary objects in the image are detected by identifying a shift for portions of the image that are most similar with the shift detected using the sensor.

At logical block 812, for image stabilization, instead of obtaining one image with a long exposure time, the device may obtain multiple consecutive images with short exposure times. These images are typically underexposed. Simultaneously, the movement of the camera can be captured by logging data from inertial sensors like gyroscopes and accelerometers. In a manner similar to that described above, multiple images can be aligned by identifying the portions of the image which correspond to stationary objects and calculating the shift in those portions of the image. These aligned images can then be cropped and added or averaged to create a new image which will have significantly reduced blur compared to an image that may not have used the techniques described herein.

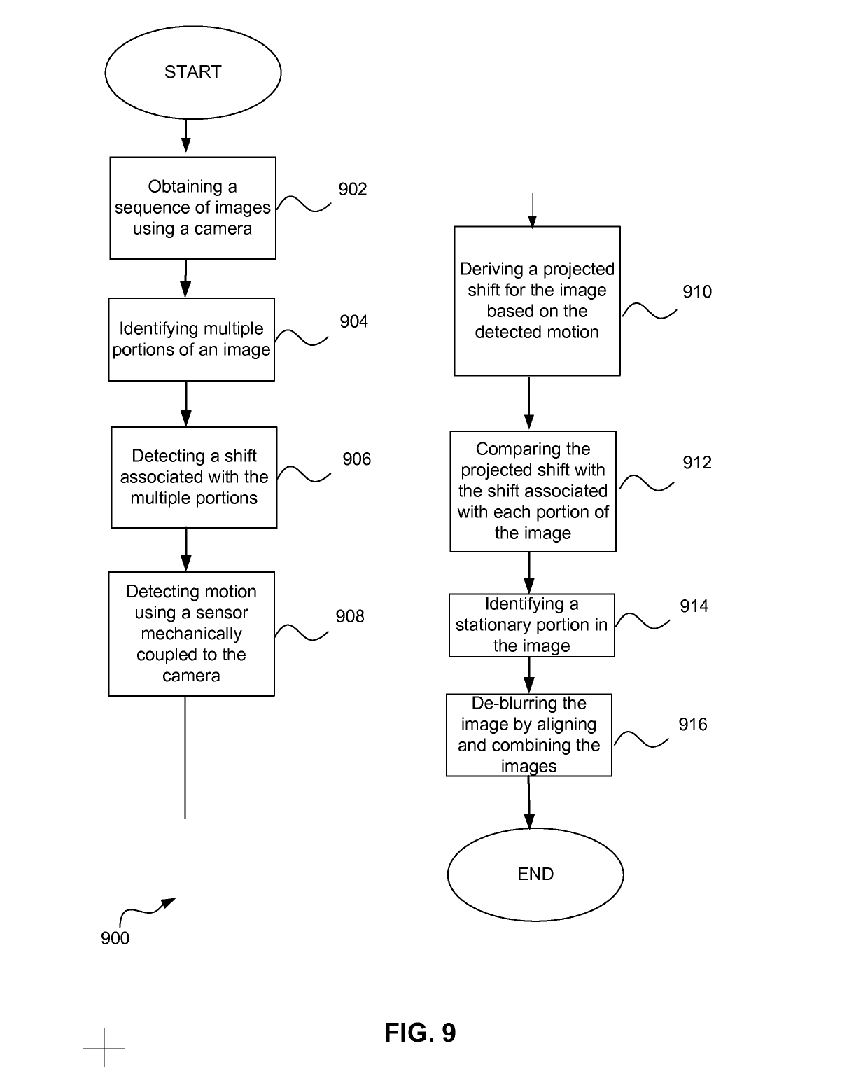

FIG. 9 is a flow diagram, illustrating an embodiment of the invention for de-blurring an image. The method 900 is performed by processing logic that comprises hardware (circuitry, dedicated logic, etc.), software (such as is run on a general purpose computing system or a dedicated machine), firmware (embedded software), or any combination thereof. In one embodiment, the method 900 is performed by device 1200 of FIG. 12.

Referring to FIG. 9, at block 902, the camera mechanically coupled to the device obtains a sequence of images for de-blurring the image. To avoid the blur caused by long exposure time, instead of obtaining one image for a picture with a long exposure time, the camera may obtain multiple consecutive images with short exposure times. These images are typically underexposed. The camera may have an image sensor, lens, storage memory and various other components for obtaining an image.

At block 904, the device identifies multiple portions from an image from the sequence of images. Multiple portions from an image may be identified using a number of suitable methods. In one aspect, the image is obtained in a number of portions. In another aspect, the image is obtained and then separate portions of the image are identified. A portion of the image may be a sub-frame, wherein the sub-frames are groupings of pixels that are related by their proximity to each other, as depicted in FIG. 5(B). In other aspects, portions of the image analyzed using image processing for detecting motion could be features such as corners and edges. Techniques such as scale invariant features transform (SIFT) can be used to identify such features as portions of the images. Alternately, optical flow or other suitable image statistics can be measured in different parts of the image and tracked across frames.

At block 906, the device detects a shift associated with each of the multiple portions a sequence of images. The shift detected in the image using image processing techniques is a combination of the shift due to motion from the device capturing the image and shift due to moving objects in the field of view of the camera. In one aspect, the shift associated with each of the multiple portions of the image is detected by analyzing a sequence of images. For example, from each image from a sequence of images, a portion from the image with the same relative location in the image is associated to form a sequence of portions from the images. Deviations in the sequence of portions from the images may be analyzed to determine the shift associated with that particular portion of the image. As described herein, a sequence of images is a set of images obtained one after the other by the camera coupled to the device, in that order, but is not limited to obtaining or utilizing every consecutive image in the sequence of images.

At block 908, the device detects motion using one or more sensors mechanically coupled to the camera. In one aspect, the sensors are inertial sensors that comprise accelerometers and gyroscopes. Current inertial sensor technologies are focused on MEMS technology. However, other technologies are also being researched for more sophisticated inertial sensors, such as Micro-Optical-Electro-Mechanical-Systems (MOEMS), that remedy some of the deficiencies related to capacitive pick-up in the MEMS devices. In addition to inertial sensors, other sensors that detect motion related to acceleration, or angular rate of a body with respect to features in the environment may also be used in quantifying the motion associated with the camera.

At block 910, the device derives a projected shift for the image based on the detected motion of the camera using the sensor. The projected image shift due to the camera motion (as measured by the inertial sensors) is calculated by appropriately scaling the camera movement taking into account the camera's focal length, pixel pitch, etc.

At block 912, the device compares the projected shift detected using the sensor with the shift associated with each portion of the image. Shift detected using the sensor and shift detected using image processing techniques for each portion of the image are compared to find a shift associated with a portion from the image which is most similar with the motion detected using the sensor. At block 914, the device identifies a shift associated with a portion from the image which is most similar with the shift due to the motion detected using the sensor, as a stationary portion of the image. One or more portions may be identified as stationary portions in the image. The comparison between the motion from the sensor and the motion from the portions of the image for similarity may be a correlation, sum of squares or any other suitable means.

At block 916, for image stabilization, once a stationary component or object from the image is identified, the image is transformed. In one aspect, the image is transformed by aligning the images/frames to each other using the shift of the images with respect to each other. The image is aligned using image rotations, shifts or other transforms calculated from the stationary component and applied to the entire image frame. The aligned images may be cropped to disregard the extraneous borders. In some instances, the images are underexposed due to the short exposure shots described in block 902. In one aspect, the images are added together resulting in an image with normal total exposure. In another aspect, where the images have adequate exposure, a technique for averaging the exposure of the images may be used instead. Other techniques can be used to combine the images so as to mitigate the increase in noise caused by the increased image sensor gain.

Moving objects in the field of view that typically cause errors in image processing based video stabilization do not degrade performance of this technique, since the moving regions of the image are frame in the discounted while calculating the shift in the image. The images may also need cropping to disregard extraneous borders without overlapping portions. These different aligned images can then be combined to form a motion-stabilized video.

In one embodiment, the image may be directly transformed using the projected shift calculated using the motion detected by the sensors. However, it may be advantageous to use the actual shift in the portions of the image that are derived using image processing techniques for the stationary portions to adjust the entire image than directly using the projected shift for the transformation. For instance, even though the projected shift and the shift calculated for the stationary portions are similar, the projected shift may have inaccuracies introduced due to the calibration of the sensors or noise in the environment of the sensors. Furthermore, the projected shift of the image may be a scaled estimation based on the focal length and may have inaccuracies for that reason as well. Therefore, it may be advantageous to 1) identify the stationary portion (using the projected shift that is derived from the motion detected from the sensors) and 2) use the calculated shift (derived by using image processing techniques) for the stationary portion of the image to transform or adjust the entire image.

It should be appreciated that the specific steps illustrated in FIG. 9 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 900.

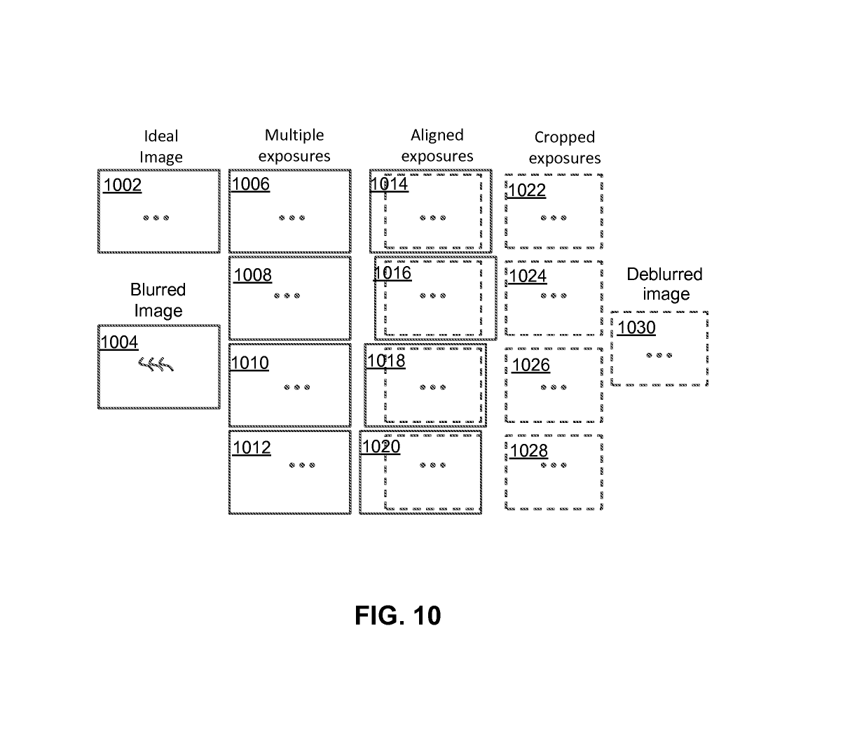

FIG. 10 is an illustration of an embodiment of the invention for de-blurring the resultant image. Using a traditional camera, the user may need to take a picture using a long exposure, especially during times of low light, causing blur due to camera shake. Block 1002 is a depiction of an ideal image for the user handling the camera. However, the original image obtained if the user used traditional means of obtaining an image using long exposure times may be blurred as depicted in block 1004. Blur is common in low light conditions and also when there is significant motion in the background.

As described above, using aspects of the invention, the device captures multiple shots with short exposure times (blocks 1006, 1008, 1010 and 1012) instead of one shot with a long exposure time. Using methods described above, specifically while discussing FIG. 10 (from 1004B-1014B), the device aligns each image in the sequence of images (blocks 1014, 1016, 1018, and 1020). Once the images are aligned, the device may crop out the extraneous borders (blocks 1022, 1024, 1026 and 1028) and composite the multiple images to create one image out of the multiple aligned and cropped images. In some aspects of the invention, the multiple images from the sequence of images may be composited by either adding or averaging the data points to generate the resulting de-blurred image. If the images are underexposed due to the short exposure shots, in one aspect, the data points from the exposures of the images are added together resulting in an image with normal total exposure times (as shown in block 1030). Data points from the image may include but are not limited to pixel color, pixel pitch, and exposure at any given point in the image. Therefore, the de-blurred image utilizing aspects of the invention (as shown in block 1030) may be much closer to the desired image (shown in block 1002) than an image taken using techniques in the related art. In another aspect, where the images have adequate exposure, a technique for averaging the exposure of the images may be used instead.

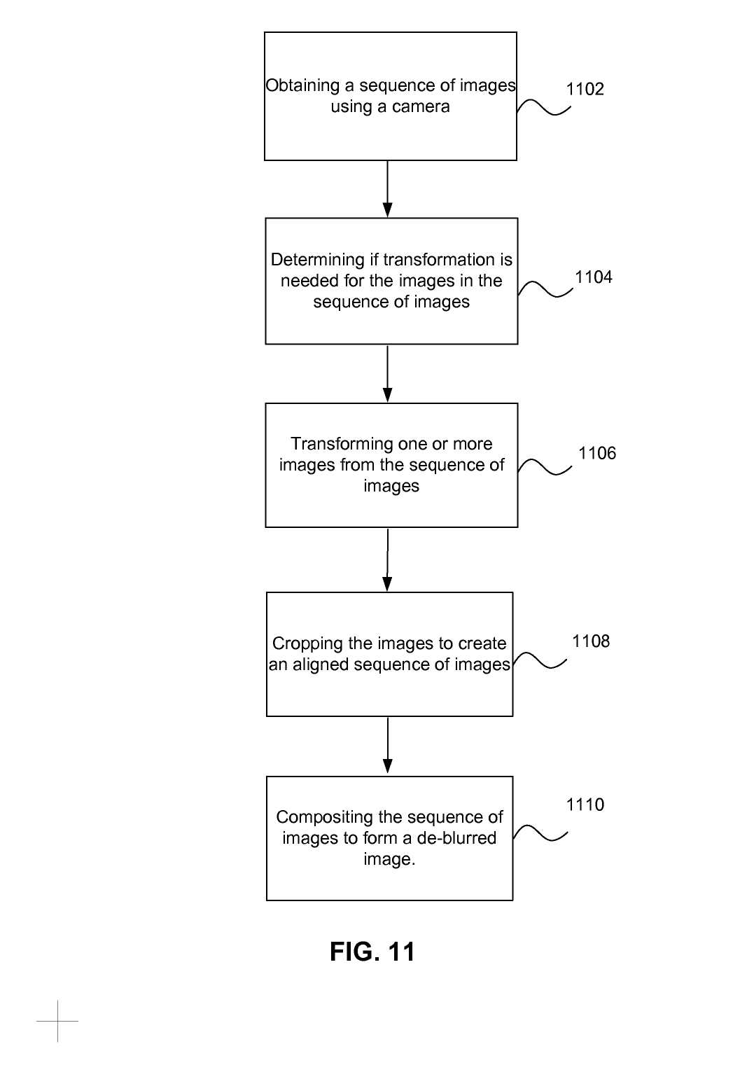

FIG. 11 is a flow diagram, illustrating an embodiment of the invention for de-blurring an image. The method 1100 is performed by processing logic that comprises hardware (circuitry, dedicated logic, etc.), software (such as is run on a general purpose computing system or a dedicated machine), firmware (embedded software), or any combination thereof. In one embodiment, the method 1100 is performed by device 1200 of FIG. 12.

Referring to FIG. 11, at block 1102, the camera obtains a sequence of images. As described herein, a sequence of images is a set of images obtained one after the other, in that order, but is not limited to obtaining or utilizing every consecutive image in a sequence of images. For example, in detecting the motion associated with a sequence of images, from a consecutive set of images containing the set of images 1, 2, 3, 4, 5, 6, 7, 8, and 9, the image processing technique may only obtain or utilize the sequential images 2, 6 and 9 in determining the motion associated with different portions of the image.

At block 1104, a plurality of images from the sequence of images are analyzed. For each image that is analyzed, the device may determine if the image is affected by a shift in the image in relation to the other images in the sequence of images for the video frame. The device may make this determination by discovering the stationary object in the image and analyzing the shift for that stationary object. For instance, if the device detects a significant shift associated with the stationary portion of image, the device may determine that a transformation of the image is needed. In another aspect, the device may perform image processing techniques on the image to determine that a transformation of the image would be advantageous.

At block 1106, the one or more images from the sequence of images that are selected for transformation at block 1104 are transformed according to embodiments of invention as described in reference to FIG. 8, FIG. 6 and FIG. 10. At block 1108, the images may be cropped to align the sequence of images in one embodiment and features and portions of the image in another embodiment. At block 1108, the images from the aligned sequence of images are combined to form a single image with adequate exposure. In one embodiment, only transformed images are combined or composited to form the resultant de-blurred image (block 1110). However, in another embodiment, the transformed images may be combined with images that were not transformed (because there was low or no shift associated with these non-transformed images).

It should be appreciated that the specific steps illustrated in FIG. 11 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 11 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 1100.

A computer system as illustrated in FIG. 12 may be incorporated as part of the previously described computerized device. For example, computer system 1200 can represent some of the components of a hand-held device. A hand-held device may be any computing device with an input sensory unit like a camera and a display unit. Examples of a hand-held device include but are not limited to video game consoles, tablets, smart phones and mobile devices. FIG. 12 provides a schematic illustration of one embodiment of a computer system 1200 that can perform the methods provided by various other embodiments, as described herein, and/or can function as the host computer system, a remote kiosk/terminal, a point-of-sale device, a mobile device, a set-top box and/or a computer system. FIG. 12 is meant only to provide a generalized illustration of various components, any or all of which may be utilized as appropriate. FIG. 12, therefore, broadly illustrates how individual system elements may be implemented in a relatively separated or relatively more integrated manner.

The computer system 1200 is shown comprising hardware elements that can be electrically coupled via a bus 1205 (or may otherwise be in communication, as appropriate). The hardware elements may include one or more processors 1210, including without limitation one or more general-purpose processors and/or one or more special-purpose processors (such as digital signal processing chips, graphics acceleration processors, and/or the like); one or more input devices 1215, which can include without limitation a camera, sensors (including inertial sensors), a mouse, a keyboard and/or the like; and one or more output devices 1220, which can include without limitation a display unit, a printer and/or the like.

The computer system 1200 may further include (and/or be in communication with) one or more non-transitory storage devices 1225, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 1200 might also include a communications subsystem 1230, which can include without limitation a modem, a network card (wireless or wired), an infrared communication device, a wireless communication device and/or chipset (such as a Bluetooth™ device, an 1202.11 device, a WiFi device, a WiMax device, cellular communication facilities, etc.), and/or the like. The communications subsystem 1230 may permit data to be exchanged with a network (such as the network described below, to name one example), other computer systems, and/or any other devices described herein. In many embodiments, the computer system 1200 will further comprise a non-transitory working memory 1235, which can include a RAM or ROM device, as described above.

The computer system 1200 also can comprise software elements, shown as being currently located within the working memory 1235, including an operating system 1240, device drivers, executable libraries, and/or other code, such as one or more application programs 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 1200) to perform methods in accordance with the disclosure. For example, some or all of the procedures of the described methods may be performed by the computer system 1200 in response to processor 1210 executing one or more sequences of one or more instructions (which might be incorporated into the operating system 1240 and/or other code, such as an application program 1245) contained in the working memory 1235. Such instructions may be read into the working memory 1235 from another computer-readable medium, such as one or more of the storage device(s) 1225. Merely by way of example, execution of the sequences of instructions contained in the working memory 1235 might cause the processor(s) 1210 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1200, various computer-readable media might be involved in providing instructions/code to processor(s) 1210 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1225. Volatile media include, without limitation, dynamic memory, such as the working memory 1235. Transmission media include, without limitation, coaxial cables, copper wire and fiber optics, including the wires that comprise the bus 1205, as well as the various components of the communications subsystem 1230 (and/or the media by which the communications subsystem 1230 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 1210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1200. These signals, which might be in the form of electromagnetic signals, acoustic signals, optical signals and/or the like, are all examples of carrier waves on which instructions can be encoded, in accordance with various embodiments of the invention.

The communications subsystem 1230 (and/or components thereof) generally will receive the signals, and the bus 1205 then might carry the signals (and/or the data, instructions, etc. carried by the signals) to the working memory 1235, from which the processor(s) 1210 retrieves and executes the instructions. The instructions received by the working memory 1235 may optionally be stored on a non-transitory storage device 1225 either before or after execution by the processor(s) 1210.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed:

1. A method for outputting a de-blurred image, the method comprising:
obtaining a sequence of images using a camera;
transforming an image from the sequence of images, wherein transforming the image comprises:
identifying a plurality of portions of the image;
detecting a shift associated with at least one of the plurality of portions of the image;
detecting a motion using a sensor mechanically coupled to the camera;
deriving a projected shift for the image based on the detected motion of the camera using the sensor;
comparing the derived projected shift with the shift associated with the at least one of the plurality of portions of the image;
identifying the at least one of the plurality of portions of the image as a stationary portion of the image by identifying that the shift associated with the at least one of the plurality of portions is most similar to the derived projected shift; and
transforming the image using the shift associated with the stationary portion of the image; and
combining the transformed image with other images from the sequence of images to composite the de-blurred image.

2. The method of claim 1, wherein transforming the image comprises spatially aligning the image to the other images from the sequence of images.

3. The method of claim 1, wherein compositing the de-blurred image comprises adding a plurality of data points from the other images to composite the de-blurred image.

4. The method of claim 1, wherein compositing the de-blurred image comprises averaging a plurality of data points from the other images to composite the de-blurred image.

5. The method of claim 1, further comprising cropping an at least one image to include in a compositing process areas of the at least one image that have overlap with areas of at least another image from the sequence of images.

6. The method of claim 3, wherein the image from the sequence of images is underexposed.

7. The method of claim 4, wherein the image from the sequence of images has normal exposure.

8. The method of claim 1, wherein detecting the shift associated with the at least one of the plurality of portions of the image comprises:
associating, from the image, the at least one of the plurality of portions of the image with a same relative location in the other images from the sequence of images to generate a sequence of portions from the sequence of images; and
determining the shift associated with the at least one of the plurality of portions of the image using deviations in a plurality of pixels in the sequence of portions from the sequence of images.

9. The method of claim 1, wherein detecting the shift associated with the at least one of the plurality of portions of the image comprises analyzing a plurality of similarly situated corresponding portions throughout the sequence of images.

10. The method of claim 1, wherein the projected shift for the image from the sequence of images is derived using a scaled value of the motion.

11. The method of claim 1, wherein the sensor is an inertial sensor.

12. The method of claim 1, wherein the sensor is one or more from a group comprising of a gyroscope, an accelerometer and a magnetometer.

13. The method of claim 1, wherein the shift in the image is from movement of the camera obtaining the image.

14. The method of claim 1, wherein the shift in the image is from movement by an object in a field of view of the camera.

15. The method of claim 1, wherein the shift associated with the at least one of the plurality of portions of the image is correlated with the motion detected using the sensor.

16. The method of claim 1, wherein the camera is non-stationary.

17. The method of claim 1, wherein the similarity in the shift of the stationary portion of the image and the projected shift associated with the motion detected using the sensor is identified by deriving a correlation between the shift of the plurality of portions of the image and the projected shift associated with the motion detected using the sensor.

18. The method of claim 1, wherein identifying the plurality of portions of the image comprises identifying a plurality of features from the image.

19. A device, comprising:
a processor;
a camera for obtaining images;
a sensor for detecting a motion associated with the device; and
a non-transitory computer-readable storage medium coupled to the processor, wherein the non-transitory computer-readable storage medium comprises code executable by the processor for implementing a method comprising:
obtaining a sequence of images using the camera;
transforming an image from the sequence of images, wherein transforming the image comprises:
identifying a plurality of portions of the image;
detecting a shift associated with at least one of the plurality of portions of the image;
detecting the motion using the sensor mechanically coupled to the camera;
deriving a projected shift for the image based on the detected motion of the camera using the sensor;
comparing the derived projected shift with the shift associated with the at least one of the plurality of portions of the image;
identifying the at least one of the plurality of portions of the image as a stationary portion of the image by identifying that the shift associated with the at least one of the plurality of portions is most similar to the derived projected shift; and
transforming the image using the shift associated with the stationary portion of the image; and
combining the transformed image with other images from the sequence of images to composite a de-blurred image.

20. The device of claim 19, wherein transforming the image comprises spatially aligning the image to the other images from the sequence of images.

21. The device of claim 19, wherein compositing the de-blurred image comprises adding a plurality of data points from the other images to composite the de-blurred image.

22. The device of claim 19, wherein compositing the de-blurred image comprises averaging a plurality of data points from the other images to composite the de-blurred image.

23. The device of claim 19, further comprising cropping an at least one image to include in a compositing process areas of the at least one image that have overlap with areas of at least another image from the sequence of images.

24. The device of claim 21, wherein the image from the sequence of images is underexposed.

25. The device of claim 22, wherein the image from the sequence of images has normal exposure.

26. The device of claim 19, wherein detecting the shift associated with the at least one of the plurality of portions of the image comprises:
associating, from the image, the at least one of the plurality of portions of the image with a same relative location in the other images from the sequence of images to generate a sequence of portions from the sequence of images; and
determining the shift associated with the at least one of the plurality of portions of the image using deviations in a plurality of pixels in the sequence of portions from the sequence of images.

27. The device of claim 19, wherein detecting the shift associated with the at least one of the plurality of portions of the image comprises analyzing a plurality of similarly situated corresponding portions throughout the sequence of images.

28. The device of claim 19, wherein the projected shift for the image from the sequence of images is derived using a scaled value of the motion.

29. The device of claim 19, wherein the sensor is an inertial sensor.

30. The device of claim 19, wherein the sensor is one or more from a group comprising of a gyroscope, an accelerometer and a magnetometer.

31. The device of claim 19, wherein the shift in the image is from movement of the camera obtaining the image

32. The device of claim 19, wherein the shift in the image is from movement by an object in a field of view of the camera.

33. The device of claim 19, wherein the shift associated with the at least one of the plurality of portions of the image is correlated with the motion detected using the sensor.

34. The device of claim 19, wherein the camera is non-stationary.

35. The device of claim 19, wherein the similarity in the shift of the stationary portion of the image and the projected shift associated with the motion detected using the sensor is identified by deriving a correlation between the shift of the plurality of portions of the image and the projected shift associated with the motion detected using the sensor.

36. The device of claim 19, wherein identifying the plurality of portions of the image comprises identifying a plurality of features from the image.

37. A non-transitory computer-readable storage medium coupled to a processor, wherein the non-transitory computer-readable storage medium comprises code executable by the processor for implementing a method comprising:
obtaining a sequence of images using a camera;
transforming an image from the sequence of images, wherein transforming the image comprises:
identifying a plurality of portions of the image;
detecting a shift associated with at least one of the plurality of portions of the image;
detecting a motion using a sensor mechanically coupled to the camera;
deriving a projected shift for the image based on the detected motion of the camera using the sensor;
comparing the derived projected shift with the shift associated with the at least one of the plurality of portions of the image;
identifying the at least one of the plurality of portions of the image as a stationary portion of the image by identifying that the shift associated with the at least one of the plurality of portions is most similar to the derived projected shift; and
transforming the image using the shift associated with the stationary portion of the image; and
combining the transformed image with other images from the sequence of images to composite a de-blurred image.

38. The non-transitory computer-readable storage medium of claim 37, wherein transforming the image comprises spatially aligning the image to the other images from the sequence of images.

39. The non-transitory computer-readable storage medium of claim 37, wherein compositing the de-blurred image comprises adding a plurality of data points from the other images to composite the de-blurred image.

40. The non-transitory computer-readable storage medium of claim 37, wherein compositing the de-blurred image comprises averaging a plurality of data points from the other images to composite the de-blurred image.

41. The non-transitory computer-readable storage medium of claim 37, further comprising cropping an at least one image to include in a compositing process areas of the at least one image that have overlap with areas of at least another image from the sequence of images.

42. The non-transitory computer-readable storage medium of claim 39, wherein the image from the sequence of images is underexposed.

43. The non-transitory computer-readable storage medium of claim 40, wherein the image from the sequence of images has normal exposure.

44. The non-transitory computer-readable storage medium of claim 37, wherein detecting the shift associated with the at least one of the plurality of portions of the image comprises:
associating, from the image, the at least one of the plurality of portions of the image with a same relative location in the other images from the sequence of images to generate a sequence of portions from the sequence of images; and
determining the shift associated with the at least one of the plurality of portions of the image using deviations in a plurality of pixels in the sequence of portions from the sequence of images.

45. The non-transitory computer-readable storage medium of claim 37, wherein detecting the shift associated with the at least one of the plurality of portions of the image comprises analyzing a plurality of similarly situated corresponding portions throughout the sequence of images.

46. The non-transitory computer-readable storage medium of claim 37, wherein the projected shift for the image from the sequence of images is derived using a scaled value of the motion.

47. The non-transitory computer-readable storage medium of claim 37, wherein the sensor is an inertial sensor.

48. The non-transitory computer-readable storage medium of claim 37, wherein the sensor is one or more from a group comprising of a gyroscope, an accelerometer and a magnetometer.

49. The non-transitory computer-readable storage medium of claim 37, wherein the shift in the image is from movement of the camera obtaining the image.

50. The non-transitory computer-readable storage medium of claim 37, wherein the shift in the image is from movement by an object in a field of view of the camera.

51. The non-transitory computer-readable storage medium of claim 37, wherein the shift associated with the at least one of the plurality of portions of the image is correlated with the motion detected using the sensor.

52. The non-transitory computer-readable storage medium of claim 37, wherein the camera is non-stationary.

53. The non-transitory computer-readable storage medium of claim 37, wherein the similarity in the shift of the stationary portion of the image and the projected shift associated with the motion detected using the sensor is identified by deriving a correlation between the shift of the plurality of portions of the image and the projected shift associated with the motion detected using the sensor.

54. The non-transitory computer-readable storage medium of claim 37, wherein identifying the plurality of portions of the image comprises identifying a plurality of features from the image.

55. An apparatus for de-blurring images, comprising:
means for obtaining a sequence of images using a camera;
means for transforming an image from the sequence of images, wherein transforming the image comprises:
means for identifying a plurality of portions of the image;
means for detecting a shift associated with at least one of the plurality of portions of the image;
means for detecting a motion using a sensor mechanically coupled to the camera;
means for deriving a projected shift for the image based on the detected motion of the camera using the sensor;
means for comparing the derived projected shift with the shift associated with the at least one of the plurality of portions of the image;
means for identifying the at least one of the plurality of portions of the image as a stationary portion of the image by identifying that the shift associated with the at least one of the plurality of portions is most similar to the derived projected shift; and
means for transforming the image using the shift associated with the stationary portion of the image; and
means for combining the transformed image with other images from the sequence of images to composite a de-blurred image.

56. The apparatus of claim 55, wherein compositing the de-blurred image comprises a means for adding a plurality of data points from the other images to composite the de-blurred image, wherein the image from the sequence of images is underexposed

57. The apparatus of claim 55, wherein compositing the de-blurred image comprises a means for averaging a plurality of data points from the other images to composite the de-blurred image.

58. The apparatus of claim 55, further comprising cropping an at least one image to include in a compositing process areas of the at least one image that have overlap with areas of at least another image from the sequence of images.
